(19) United States
(12) Patent Application Publication
(10) Pub. No.: US 2026/0216836 A1
(43) Pub. Date: Jul. 30, 2026

(54) METHOD FOR COATING AND MACHINING COMPONENTS

(71) Applicant: Fraunhofer-Gesellschaft zur Förderung der angewandten Forschung e.V., München (DE)

(72) Inventors: Matthias BRUCKI, Aachen (DE); Viktor GLUSHYCH, Aachen (DE); Max Gero ZIMMERMANN, Aachen (DE)

(73) Assignee: Fraunhofer-Gesellschaft zur Förderung der angewandten Forschung e.V., München (DE)

(21) Appl. No.: 19/146,949

(22) PCT Filed: Jan. 9, 2024
(86) PCT No.: PCT/EP2024/050355

§ 371 Date: Jul. 10, 2025

(30) Foreign Application Priority Data
Jan. 12, 2023 (DE) 10 2023 100 617.7

(51) Int. Cl. B23P 23/04; B05B 7/22; B05B 13/04

(52) U.S. Cl. CPC B23P 23/04; B05B 7/228; B05B 13/0436

(57) ABSTRACT

The present invention relates to a method for processing a component, in which method the component is coated using at least one coating process and the component and/or a coating applied to the component using the coating process is machined using at least one machining process. The method is characterised in that the machining process and the coating process are performed on the component at least temporarily at the same time, i.e. in parallel. The method reduces the costs and production times for machining the component.

### TECHNICAL APPLICATION AREA

The present invention relates to a method for processing a component, in which the component is coated by at least one coating process and the component and/or a coating applied to the component by the coating process is processed by at least one machining process. The use of the suggested method lies primarily in the area of coating components.

After coating a base body, e.g., to increase corrosion resistance or hardness, in many cases the surface quality required for the function has not yet been obtained. The coating process is therefore followed by final processing in a machining process such as turning, grinding or honing. The manufacture of components using manufacturing technologies such as coating and machining leads to significant cost and time disadvantages as well as technical disadvantages due to the sequential organisation of the process chain. Furthermore, components in the process chain are usually unclamped after each process step and at the end of processing and clamped into the next machine again for the subsequent processing step. The additional re-clamping process leads to deviations during clamping, which in turn can result in deviations in the shape and dimensional tolerance of the finished component. These deviations result in different coating thicknesses across the component after the machining process. Due to the different material properties of the base and coating materials, residual stresses can arise in the component, which lead to the component failing under continuous load.

### PRIOR ART

As a rule, coating and machining are carried out in several consecutive steps. According to DE 10 2005 008 569 A1 for example, when coating brake discs the irregularities in the coating surface are removed by means of a subsequent surface grinding. In EP 2 773 881 B1, brake discs are pre-processed with abrasives before the coating process in order to obtain the surface necessary for the high adhesive tensile strength.

The successive processing of workpieces is usually carried out by modifying the workpiece in a machine designed for the respective coating or machining process. For example, a component is first pre-processed in a turning centre, then modified in a coating system and, after the coating process, clamped into a turning centre again for finishing. According to DIN 6386-2, the permissible concentricity tolerances TR for power-operated lathe chucks are between 30 μm and 120 μm. Such a deviation in concentricity is often disadvantageous for coating processes, which means that the workpiece must be aligned manually after each modification process. Frequent modification reduces the productivity of the process chain.

An alternative to this are hybrid machine tools, in which the workpiece remains in one clamping fixture and the tool is changed between the process steps. With the hybrid design, the modification effort can be minimised, since the workpiece only needs to be aligned once. In EP 1 859 893 A1, a hybrid machine tool is described that enables automated conversion of the laser processing tool to a cutting tool.

The object of the present invention is to provide a method for processing a component by coating and machining, which enables shorter production times.

### SUMMARY OF THE INVENTION

The object is achieved with the method according to claim 1. Advantageous variants of the method are the subject matter of the dependent patent claims or are discernible from the following description and the exemplary embodiment.

In the suggested method, the component is coated in at least one coating process. The component and/or the coating applied to the component by the coating process is also machined in at least one machining process. The method is characterized in that the machining process and the coating process are carried out on the component simultaneously at least for some of the time. In other words, machining and coating are carried out at least temporarily parallel to each other, with the tools of both individual processes interacting with the same component at least temporarily at the same time.

The method may be used in different ways and/or for different applications. For example, the machining process can be used to smooth the surface of a coating applied to the component by the coating process. In this case, the machining process follows the coating process. It is also possible to process the surface of the component with the machining process before the coating, in particular to prepare it for coating. In this case, the coating process then follows the machining process. In the first case, the time interval between the coating process and the machining process—at least for some of the areas to be processed, preferably for each area of the component that is to be processed—is preferably chosen to be short enough that the heat generated by the coating process in the component and/or the layer applied softens the material for the subsequent machining process. This use of process heat for the subsequent machining process enables faster processing speeds, as the machinability of high-strength or difficult-to-machine materials is improved as a result. In the second case, the machining process preferably removes impurities from the surface of the component and defines its geometry before the coating. This leads to a reduction in geometry-related deviations in the coating process and increases the dimensional stability/final contour accuracy of the component.

The suggested method also enables the application of a multilayer coating by the coating process. A variant in which the component is first prepared for coating by a first machining process and the coating is in turn smoothed by a second machining process is also possible. In this case, all three processes—the first machining process, the coating process and the second machining process—can then run in parallel on the component at times.

In the suggested method, the component is preferably clamped in a clamping fixture and rotated for the coating and machining processes. Alternatively, the tool holders of the tools used for processing may also rotate around the clamped component. Processing is carried out accordingly in a hybrid machine tool that offers both processing options at the same time. Coating and machining are preferably carried out at the same speed. This speed is preferably selected such that the surface speeds of the component during parallel processing are above 1000 mm/min (relative to the tool holders).

In principle, different feed rates can be selected for the machining process and the coating process. However, it is particularly advantageous to carry out both processes with the same feed rate, as this enables a constant time offset between the two processes.

In the suggested process, the coating is preferably carried out using a laser-based process, in particular laser cladding. Extreme high-speed laser cladding (EHLA) is used particularly advantageously. Of course, in principle other coating processes are also possible, for example thermal spraying. Metallic materials, ceramic materials, polymers or metal matrix composites can be used as coating materials. The coating is preferably applied to the component with a thickness of >10 μm.

The machining process can be carried out by turning, grinding or honing, for example. Machining can also be carried out by milling with a milling tool, wherein the coating speed of the coating process and the cutting speed of the machining process are preferably selected to be identical.

The suggested method offers a cost advantage over techniques that use separate machines for coating and machining. Investments in a second machine frame, a corresponding rotation unit and associated control components are eliminated, as both processing operations can take place on the same machine. By processing for at least some of the time in parallel the production times for each component are shortened by eliminating a processing step. The method enables the production of coatings with high surface quality through simultaneous processing.

Processing in the same clamping fixture reduces the residual stresses induced by the machining process and therewith also the resulting distortion of the component. When building up multilayer coatings, the intermittent machining of the component before the material is applied leads to a reduction in geometry-related deviations in the coating process, with the result that the dimensional accuracy and/or final contour accuracy of the component is improved. Comparable to laser-assisted turning or milling, machining the coating immediately after the coating process means that the material can be processed in a temperature range in which the tensile strength and thus also the hardness of the material is significantly lower. This yields both economic and technical advantages. The method enables the processing of difficult-to-machine and high-strength materials with less wear on the cutting tool and at higher speeds. The use of the process heat from the immediately preceding coating process also leads to a reduction in porosity and microcracks in the edge zone, a reduction in residual stresses in the edge zone and a reduction in process forces that must be absorbed by the machine tool during machining.

The method is suitable for all applications in which components were previously coated and machined sequentially. The method may be used, for example, to produce coatings for corrosion and wear protection, adhesive and non-stick coatings, electrically and thermally insulating coatings, coatings with hard and soft magnetic properties, and to produce plain bearing coatings and functional surfaces. The method can also be used to repair damage close to the surface. It is particularly suitable for applications that traditionally rely on chemical and galvanic methods, such as hard chromium plating, chemical and galvanic nickel plating, galvanising, etc. Coatings of such kind are required for example in the energy industry, the automotive and transport sector, the metal and steel industry, the food industry, the plastics industry, the chemical industry, the paper industry, the aerospace industry, the mining industry, or in tool and plant construction. Examples of applications include the production of wear-resistant coatings for calenders in plastic extrusion or for rollers in steel processing (e.g. cold rolling, hot rolling), the production of corrosion-resistant coatings for rollers in paper production or the production of brake disc coatings.

### BRIEF DESCRIPTION OF THE DRAWING

The proposed method will be explained again in greater detail below with reference to an exemplary embodiment in conjunction with the drawings. In the drawings:

FIG. 1 is a representation of the ranges for the coating speed or cutting speed and the feed when processing a component using EHLA and turning using the example of the material WC—Co;

FIG. 2 is a schematic representation of a variant of the suggested method in a side view of the component; and

FIG. 3 is a schematic representation of the variant of FIG. 2 in a view in the axial direction of the component.

### WAYS TO IMPLEMENT THE INVENTION

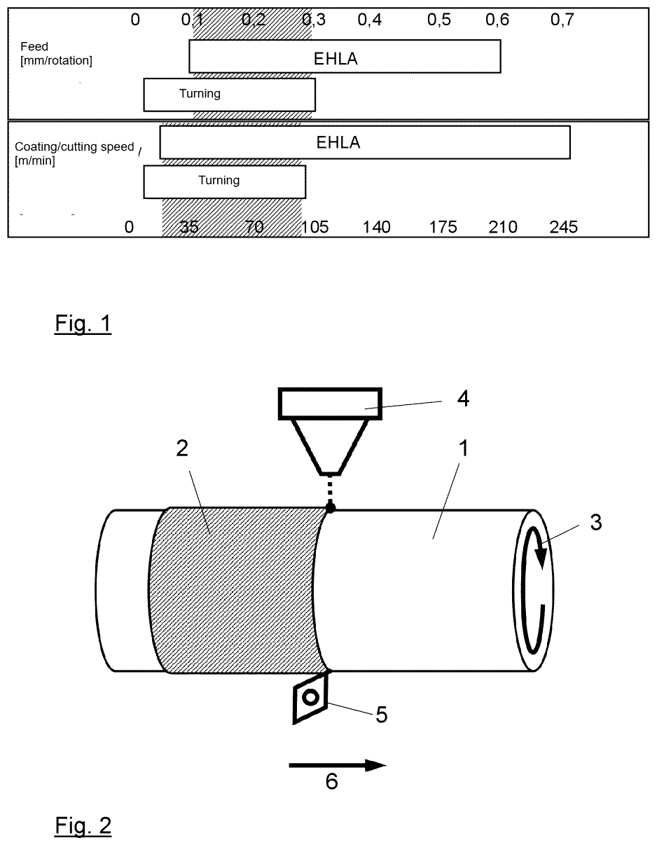

The method will be explained again below with reference to an exemplary embodiment in which a component, also referred to as the workpiece, is coated by laser cladding, and the applied coating is smoothed by turning. For this purpose, a lathe is used which is also equipped with a suitable laser processing head for laser cladding. The component is clamped in the lathe's clamping system and rotated during processing. This makes it possible to exploit the fact that the speeds and feed rates required for turning overlap with the speeds and feed rates required for coating using the EHLA (extreme high-speed laser cladding) used in the present example. This is shown schematically by the application of the material WC—Co in FIG. 1. From this figure it can be seen that the lathe speeds required for both processing methods overlap in the range from about 20 to 100 m/min. The same applies for the feed rates in the range from 0.1 to 0.3 mm/revolution. Therefore, speeds and feed rates in these ranges are preferably used for processing this material according to the suggested method. Similar conditions also apply for other materials.

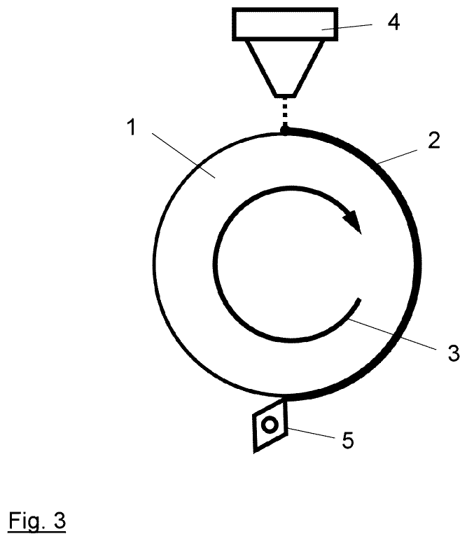

FIG. 2 shows a side view of the workpiece processed according to this example during processing according to the suggested method. The workpiece 1 is rotated accordingly, wherein the direction of rotation 3 is indicated in the figure. In this example, the coating is applied with a processing head 4 for laser cladding (here EHLA). The coating 2, which has already been partially applied, can be seen on the workpiece 1. The coating is smoothed by turning in parallel using masked time, as is indicated by the turning tool 5 in the figure. In this example, every point on the workpiece 1 that has just been coated is already machined accordingly after half a rotation. The relative movement 6 between the coating and/or cutting tool and the workpiece 1 is indicated by the arrow.

FIG. 3 shows the same process again when looking in the axial direction of the workpiece 1. As the machining process takes place immediately after the coating process, the process heat introduced by the coating process is used to reduce the tensile strength and thus the hardness of the material for machining. This enables faster processing and reduces wear on the cutting tool. In this example, the machining that follows the coating takes place with a half-rotation delay. However, the delay can also be set to be shorter or longer.

### LIST OF REFERENCE NUMERALS

1 Workpiece/component
2 Coating
3 Direction of rotation
4 Processing head for laser cladding
5 Turning tool
6 Relative and feed motion

1. Method for processing a component, in which the component is coated by at least one coating process, and the component and/or a coating applied to the component by the coating process is processed by at least one machining process,
characterized in that
the machining process and the coating process are carried out simultaneously at least for some of the time.

2. Method according to claim 1,
characterized in that
with the machining process a surface of the coating applied by the coating process is smoothed.

3. Method according to claim 1,
characterized in that
a surface of the component is processed with the machining process before the coating.

4. Method according to claim 2,
characterized in that
a time interval between the coating process and the machining process is chosen to be short enough to enable the heat produced by the coating process to cause a softening of the material applied in the coating process for the subsequent machining process.

5. Method according to claim 3,
characterized in that
the surface of the component is freed from impurities and geometrically determined by the machining process before coating.

6. Method according to claim 1,
characterized in that
the component is clamped into a clamping fixture during processing, and either the component is rotated or the tool holders for the coating and machining process are rotated about the component at a speed that is chosen to be identical for the coating process and the machining process.

7. Method according to claim 6,
characterized in that
the speed is chosen such that surface speeds of the component during processing are above 1000 mm/min relative to the tool holders.

8. Method according to claim 1,
characterized in that
the coating process and the machining process are carried out with the same feed speed.

9. Method according to claim 1,
characterized in that
a coating speed of the coating process and a cutting speed of the machining process are selected to be identical.

10. Method according to claim 1,
characterized in that
the coating process is performed using a laser-based method, in particular using laser cladding.

11. Method according to claim 1,
characterized in that
with the coating process a coating with a thickness greater than 10 μm is applied to the component.

12. Method according to claim 1,
characterized in that
the component is coated with a metallic material, a ceramic material, a polymer or a metal-matrix-composite.
